(19) United States
(12) Patent Application Publication
(10) Pub. No.: US 2024/0303233 A1
(43) Pub. Date: Sep. 12, 2024

(54) GENERATING PROCESS INSIGHTS FOR SOFTWARE SYSTEM

(71) Applicant: SAP SE, Walldorf (DE)

(72) Inventors: Volker von Gloeden, Walldorf (DE); Stefan Voll, Stutensee-Spöck (DE); Sven Hoffmann, Walldorf (DE); Gregor Berg, Berlin (DE); Bastian Hoeltkemeier, Berlin (DE)

(21) Appl. No.: 18/118,857

(22) Filed: Mar. 8, 2023

(51) Int. Cl. G06F 16/242; G06Q 10/0633

(52) U.S. Cl. CPC G06F 16/2423; G06Q 10/0633

(57) ABSTRACT

The example embodiments are directed to systems and methods which can generate process insights in a manner that is significantly faster than process mining. In one example, a method may include loading a schema of a data system into memory, identifying a plurality of events that occur within a process supported by data from the data system and a plurality of blockers that prevent the plurality of events from completing, defining a query that comprises instructions for extracting data of the plurality of blockers from the data system and for analyzing the process based on the extracted data and the plurality of blockers, and generating a script for executing the defined query based on the schema of the data system and transmit the script to a software application.

### BACKGROUND

Many organizations rely on enterprise resource planning (ERP) software to run their business process. ERP helps companies create and track orders, generate and clear invoices, receive payments, interact with a website, and the like. ERP software also offers opportunities to perform process mining on the business process. Process mining is a technique that provides insight about a business process to an organization. In many cases, process mining includes executing algorithms on log data from a runtime environment of the business process to identify trends, patterns, variants and other details of the process and how it unfolds. However, process mining usually involves customization of analyses provided by process mining vendors which mine the business process including building dashboards and other software which can take weeks of time. Furthermore, process mining relies on hard-to-find expertise in the field of software.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a host platform for generating process insights in accordance with an example embodiment.

FIG. 2A is a diagram illustrating a schema of a data system uploaded to the host platform in accordance with an example embodiment.

FIG. 2B is a diagram illustrating a user interface for defining milestones and blockers in accordance with an example embodiment.

FIG. 2C is a diagram illustrating a process of generating an executable query for generating process insights in accordance with an example embodiment.

FIG. 3A is a diagram illustrating a process of executing a query and generating process insights in accordance with an example embodiment.

FIG. 3B is a diagram illustrating a process of identifying milestones and blockers as a subset of the overall state space in accordance with an example embodiment.

FIG. 4 is a diagram illustrating a user interface with process insight data in accordance with an example embodiment.

FIG. 5 is a diagram illustrating a method of generating process insights in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Companies and other organizations need to have insights into their core business processes if they are to plan, monitor, and evaluate any meaningful changes to their processes. Related approaches to understanding such insights are derived using process mining. A realistic timeline for performing such process mining is a few months and it requires consulting offers from process mining vendors that are familiar with the software system being mined. The result is significant time and costs being consumed. Another drawback is that process mining may “mine” the entire state space of the software which ultimately leads to a brief overview of the entire process being generated without much insight or provide a very focused analyses that only targets a very specific question. Furthermore, once a mining project is complete, the data can continue to be monitored, but the data extraction can no longer easily be modified. As a result, if a mining project requires new or different requirements, a completely new mining project will need to be created.

The example embodiments are directed to a software system (also described herein as a host system) that provides a different approach for gathering insights from a business process by analyzing the data based on standardized milestones and standardized blockers of such milestones. A milestone represents an event that occurs within the business process which should always take place within the process, regardless of its manifestation in a specific enterprise software system. For example, a business process that involves the sale of goods may include a requirement that a sales order (document) be created which identifies the goods and a requirement that an invoice (document) be generated and cleared. These three actions can be considered milestones. For example, the first milestone may be “creating a sales order”, a second milestone may be “creating an invoice”, and a third milestone may be “clearing the invoice”.

Blockers, on the other hand, are occurrences or events that block the process from moving forward and will usually remain in place until the block is removed, if they don't directly terminate process instances (e.g., the manual cancelation of an order). Referring again to the example of the three milestones above, the process may require that the buyer sign and return the sales order before the invoice can be generated by the system. In this example, failure to receive a signed sales order may be considered a blocker to the process. Until the signed sales order is received, the block will remain in place. Other contextual information reflecting such as unwanted or unintentional behavior (e.g. wrong sequence of process steps) can also be covered in such a definition of a blocker to surface these issues to the people responsible of running the process.

Such standardized milestones and blockers have been and can be identified from years of expertise in the field of process insights and avoid unnecessary mining projects which attempt to mine the entire state space of the process including parts of the process that are unrelated to the ultimate success of the process. While process mining can give you the whole state space including all irrelevant variants, paths and events, the example embodiments focus on providing those blockers typically encountered by most companies. From a commercial perspective, the customer does not have to decide on one process to understand in depth but can get insights into challenges and blockers in a standardized way across the whole process landscape. The software system may provide pages of user interfaces which enable users to choose or otherwise select a subset of milestones from the predefined/standardized list and a subset of blockers for each milestone from another predefined/standardized list.

The process experts may also develop queries for the data values that are the result of the process such as sales data, invoice data, payment data, and the like, which can be used to see how the process is performing. To do this, the host system may provide most of the query template and the experts may input the table identifiers, column identifiers, data value locations, etc. of the data to be queried to complete/fill-out the query. As another example, machine learning models, artificial intelligence models, statistical models, or the like, may be trained to fill in the query template with underlying data from the database. The resulting queries cover what a customer would be interested in a process. These queries may be combined into a single executable that can be called by at any time to show the current status of the process based on the actual data of the process without a need to mine the process using process mining. Instead, the software system described herein queries business data of the process to identify how the process is performing and generate insights that can be performed in significantly less time than process mining. In some cases, the end-to-end process can be performed in as little as a few minutes or up to a few hours. Meanwhile, process mining can take a few weeks to a few months of time.

The example embodiments provide a number of advantages with respect to current insight generating techniques such as process mining. For example, the software system may utilize standard processes for a given system to identify milestones and blockers of a process. Using predefined/standardized milestones and blockers generalizes the fastest way to insights for any enterprise system. Speed is ensured by standardizing the scope of the analysis to critical areas (milestones and blockers) including steps of the process with low efficiency, significant defects, and, generally speaking, where the process is losing/bleeding money.

As opposed to competing approaches, the system described herein only requires a one-time effort of mapping out processes [symbol] in a new system [symbol] within days, if not hours. Once this mapping is performed, insights can be generated by anyone with access to the software by connecting their instance of [symbol] to a suitable analytics app. In addition, automated generation of (parts of) the required information accelerate the approach even further by assisting the user to fill-out the necessary data via the user interface. Other offerings in the market take months to get started and to customize the analysis for only a limited number of processes.

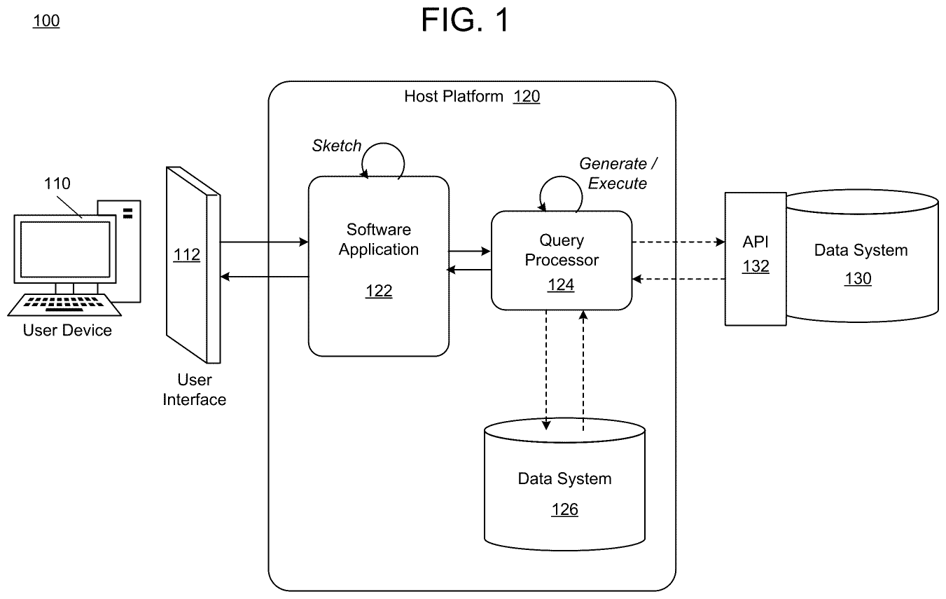

FIG. 1 illustrates a computing environment 100 of a host platform 120 for generating process insights in accordance with an example embodiment. Referring to FIG. 1, the host platform 120 may be a cloud platform, a web server, a database, a combination of devices, and the like. The host platform 120 hosts a software application 122 for generating process insights. The software application may include one or more analytic programs that can analyze a business process and generate insights. The data used by the software application 122 to generate process insights is stored in a data system, for example, data system 126 that is local to the host platform and/or data system 130 that is external to the host platform 120 and that is accessible via a network such as the Internet. As described herein, a data system may refer to a database, a website, a data service, a blockchain, or the like. The data system 126 may be accessed via an API and/or it may be accessed via a query such as a SQL query, or the like.

In this example, a user such as a process expert may interact with the software application 122 via a user device 110 such as a laptop computer, a mobile device, a desktop computer, a server, and the like. For example, the user may use the user device 110 to connect to a website, uniform resource locator (URL), or other location where the software application 122 is hosted. In some examples, the software application 122 is a progressive web application, a mobile application, or the like. In some embodiments, the software application 122 is actually a suite of multiple applications. The software application 122 may include a front-end with a user interface 112 that is output on a screen/display of the user device 110 once a session is established between the user device 110 and the host platform 120.

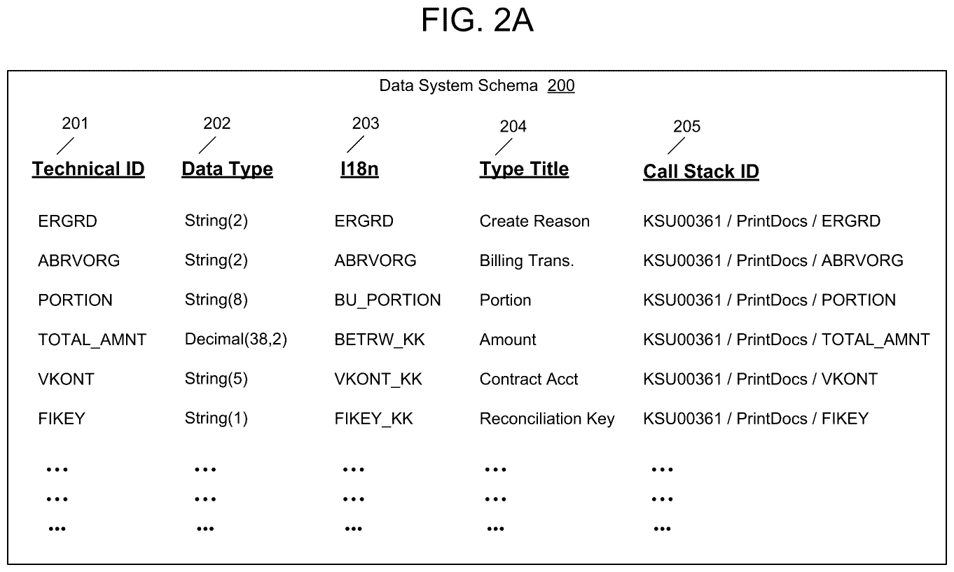

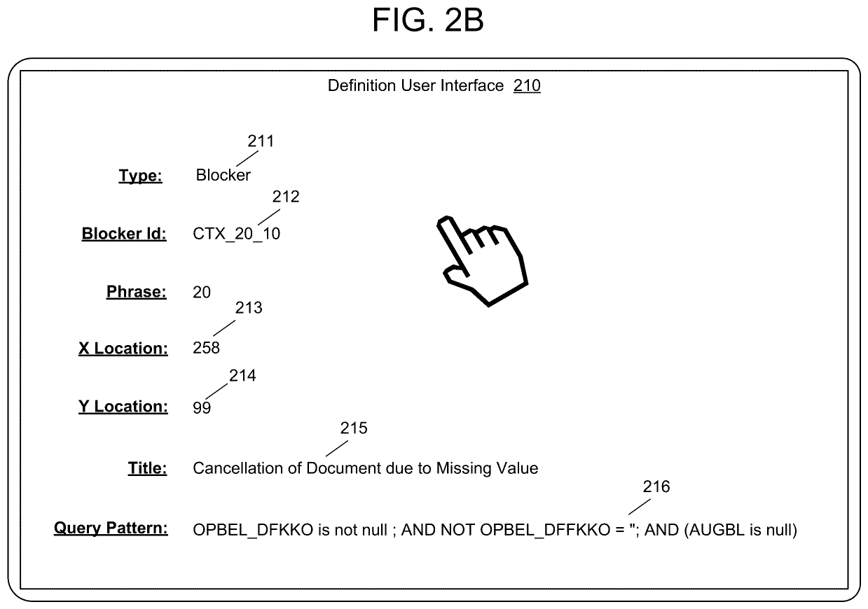

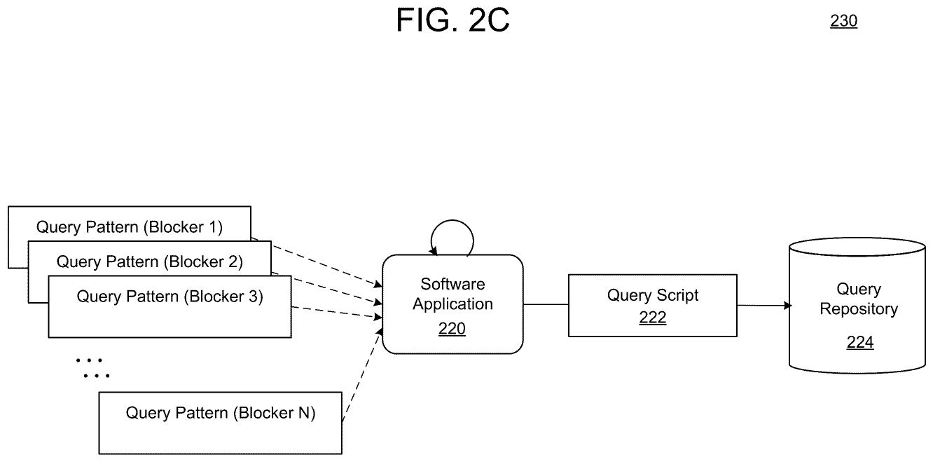

According to various embodiments, the user may select a system where the process data is located from among the data system 126 and the data system 130. In this example, the data system 130 is accessed via an application programming interface (API) 132. The software application 122 may output guidance for the user via the user interface 112 to assist the user in selecting the correct system. A schema of the selected system may be uploaded to the software application 122 via the user interface 112. For example, the user may upload a file, a document a spreadsheet, or the like which includes the schema information. An example of a schema of a data system in shown in FIG. 2A.

The software application 122 may also provide various user interfaces which enable the user to define milestones within the process and blockers for those milestones. An example of such a user interface is shown in FIG. 2B. The user interfaces may be accessible via a same page of the software application 122 or across multiple different pages of the software application 122. The user may also define a script or other instructions with query commands for querying the data necessary for analyzing the milestones and blocker(s) of the milestone via the user interface. Each blocker may have its own query, for example, a structured query language (SQL) query, or the like. The software application 122 may provide user interfaces and standardized lists of milestones and blockers (e.g., via drop-down menus, etc.) that the user can select from. Furthermore, software application 122 may also provide support and assistance in developing queries for accessing the data from the underlying data system.

When all queries for all blockers have been generated, the software application 122 may create a single script, API call, etc., which can be executed by a query processor 124 on the selected data system to extract the data necessary for analyzing each of the blockers via a single command. For example, the software application 122 may generate a structured query language (SQL) query for each of the blockers and then create a single script which extracts a union of all of the fields necessary from the data system. In some embodiments, the data system may also include an API, such as data system 130 which includes an API 132. In this example, the query generated by the software application 122 may include query commands and/or API calls for extracting the process data from the data system 130. The generated script, query, etc. may be stored by the software application 122 and accessed by the user via the user device 110 or any other user with access to the process data via the software application 122. Here, the user may provide an identifier of the process (e.g., a process ID, etc.). In response, the software application 122 may query the selected data system based on the previously generated query corresponding to the process ID, and execute an analytic(s) on the process data to generate process insights which can be displayed on the user interface 112.

FIG. 2A illustrates a schema 200 of a data system uploaded to the host platform in accordance with an example embodiment. For example, the schema 200 may be a table schema that is uploaded via a user interface of the host system or via a document or other file that can be ingested via an API or other means. The schema 200 includes attributes 201, 202, 203, 204, and 205 which can include identifiers of tables, columns, data values, etc., as well as data types, names, locations/paths to the data and/or the software stack, and the like. In response, the host system can identify how to access the data for analyzing the milestones and blockers of the milestones, for example, using type-checking and auto-completion. The actual data from the data system which is needed to calculate the metrics for the milestones and blockers depends on the queries on top of available data fields in the table. Each query for a milestone or blocker may be defined by a process expert based on these data fields, checking for specific constraints as depicted in input field 216. The sum of the required data fields in these queries identifies which table columns the host system has to retrieve from the data system to allow for the standardized process insights. The actual retrieval is then possible in a customer setting where the customer identifies the data system to be used, including providing access, e.g., via API tokens to ensure that the host system can retrieve the required data set.

FIG. 2B illustrates a user interface 210 for defining queries for extracting data and generating display values (e.g., of milestones and blockers) of a business process on a user interface for insight analysis in accordance with an example embodiment. For example, the user interface 210 includes input fields 211, 212, 213, 214, 215, and 216, which request information from the user. The input fields may be “standard” fields that request general attributes with of a blocker and/or milestone to be defined. For example, the input values entered into the fields may identify a name of the milestone or blocker, a type of the blocker, a pixel location(s) on the user interface where a graphical object corresponding to the milestone/blocker is to be displayed, and the like. In addition, the input field 216 may be used to define a query pattern for querying an underlying data system for the data to be used to analyze this milestone/blocker. In this example, a blocker is being defined. However, it should also be appreciated that milestones may also be identified/defined in a similar way using a similar user interface. Essentially, out of all the business objects such as a Sales Order in scope for the process under investigation, the query of a blocker may need to define which of many instances (e.g., hundreds of thousands of instances, etc.) are considered to be affected by the blocker. For example, a blocker identifying manually blocked sales orders would cause the system to check whether the corresponding flag found in a specific table is set to true. Then, in response to the blocker, the system could cause the end users' UI could display the amount of manually blocked sales orders, either absolute (500 items) or relative (0.5%).

FIG. 2C illustrates a process 230 of generating an executable query for generating process insights in accordance with an example embodiment. The user may use the user interface 210 in FIG. 2B to generate queries for data for analyzing all blockers of the process resulting in multiple query patterns as shown in FIG. 2C. The software application 220 may combine these queries into a query script 222 (e.g., a single script) that can be executed to extract all of the data for all of the blockers of the process at once (in a unionized view) from an underlying data system, and return a unionized result of all the values for all the fields in a data structure such as a Core Data Services (CDS) view or the like. The query script 222 can be stored within a query repository 224, or the like. As another example, the software application 220 may generate a query without using a script. As another example, the software application may generate commands for extracting the data from the underlying data system using API calls instead of or in combination with database queries.

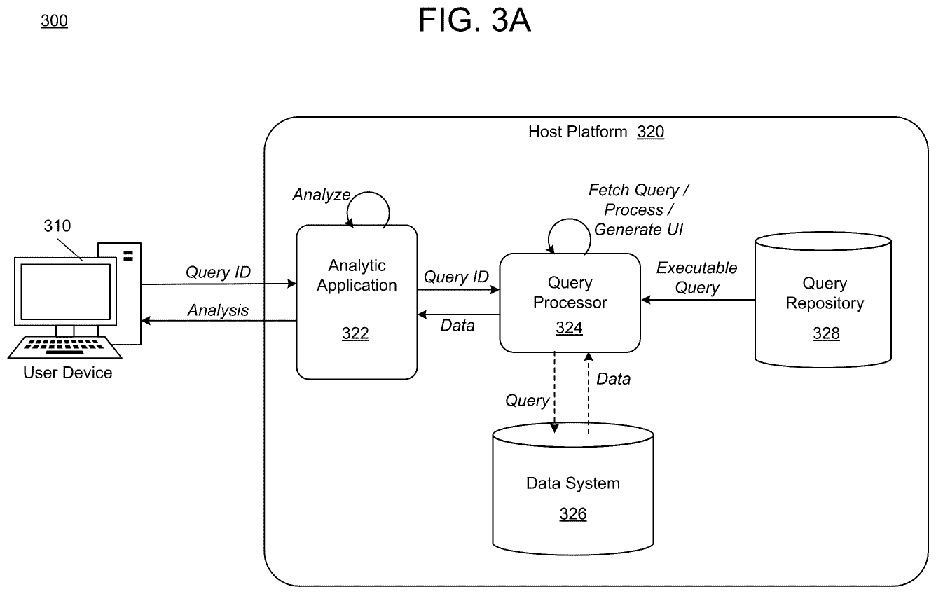

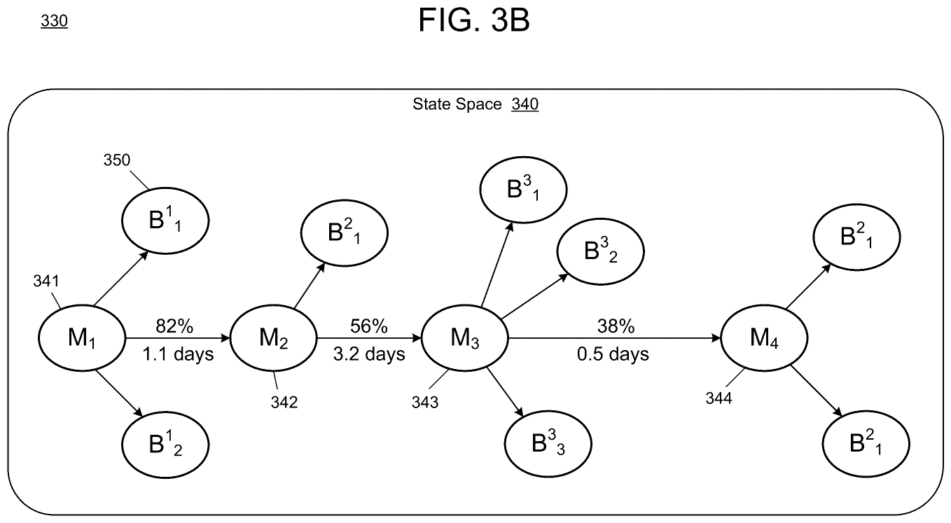

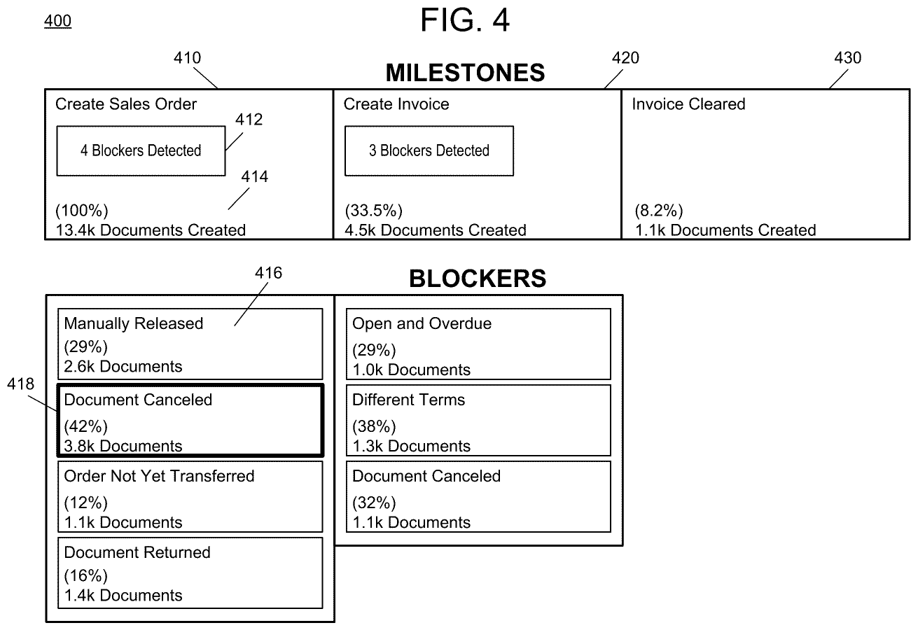

FIG. 3A illustrates a process 300 of executing a query and generating process insights in accordance with an example embodiment, and FIG. 4 illustrates an example of a user interface 400 with various insights provided by the analysis of the example embodiments. Referring to FIG. 3A, a host platform 320 hosts an analytic application 322. The analytic application 322 may be the same as the software application 122 shown in FIG. 1, or it may be a different application such as another application in the same suite of applications that interacts with or otherwise can receive and send data to the software application 122.

In this example, a user may submit a query ID of a previously-generated query that is held in a query repository 328 of the host platform 320 via a user device 310 which is connected to the host platform 320 via a network. In this example, the user corresponds to a customer (i.e., an end user of the system) and not a process expert helping build the system as was the case in FIGS. 2A-2C. The query ID may be supplied by the user inputting the query ID (e.g., string value, etc.) into a user interface of the analytic application 322 via the user device 310. Here, the analytic application 322 may pass the query ID to a query processor 324 which generates and executes a query for the process data on a data system 326. In this example, the query processor 324 uses the query ID to obtain a query (e.g., query script, API call, etc.) from the query repository 328 which includes commands and instructions for extracting the process data from the data system 326 and providing the data to the analytic application 322.

The process data that pulled/extracted from the data system 326 may include values of table data that are pulled from tables stored in the data system 326 including order data, invoice data, payment data, shipping data, transportation data, inventory data, and the like. Through this data, the analytic application 322 can analyze the data to identify insights associated with the process. For example, the analytic application 322 may identify how long it takes for each milestone to be reached (e.g., the amount of time that elapses between milestones) and the blockers that block these milestones from being achieved. To identify the duration between milestones, the analytic application 322 may use timestamps of when the process enters the two respective milestones on average and subtract the two.

For a given standard process [symbol] , the analytic application 322 can check whether the process data [symbol] collected during an execution of [symbol] (also referred to as data footprint of [symbol] in [symbol] ) fulfills the data needs of a query [symbol] . This can be performed by a team of process experts who know [symbol] and system experts who know [symbol] . With an autocompletion-support tool, these experts can define a process, its milestones and blockers (along with their respective queries) within hours. Once this is done, the standard process [symbol] is available for all customers running [symbol] on [symbol] . Customizations are out of scope for this approach as of now as each customization of [symbol] in [symbol] will incur customer-specific effort of mapping additional data fields in [symbol] to [symbol] ′ which breaks the USP of providing the fastest way to insights.

The resulting insights that are generated by the analytic application 322 may include identifications of the milestones of the process, identifications of the blockers, an amount of elapsed time on average between the milestones, the number of processes that make it to each milestone, how each blocker affects the achievement of milestones within the process, and the like. For example, in FIG. 4, a user interface 400 displays insights that identify a plurality of milestones 410, 420, and 430, and attributes of the milestones including a number of blockers 412 that are detected and attributes 414 of the milestone with respect to other milestones. In this example, the milestones 410, 420, and 430 are executed in sequence within the end-to-end business process and each involve a document. In this example, the milestones each correspond to documents involved in the process.

In this example, milestone 410 represents a step of generating a sales order, milestone 420 represents a step of generating an invoice based on the sales order, and milestone 430 represents clearing the invoice (based on successful payment). The milestone 410 includes four blockers which are show below the milestone 410 including a blocker 416 directed to manually released documents. Other blockers including cancellation of documents, not transferring an order to the invoicing department, returning the sales order for errors, and the like. To assist the user in understanding the issues, the host system can display an identifier of the number of blockers 412 within the milestone 410, and also attributes 414 of the milestone 410 inside a content area of the graphical object of the milestone 410 on the user interface 400.

In addition to identifying the amount of time and the attributes of the milestones and the blockers, the analytic application 322 may distinguish different graphical objects on the screen. As an example the analytic application 322 may highlight an object with a bold line 418 to identify this blocker as something that needs to be addressed more urgently as it is causing a lot of loss within the process. Thus, the system can identify a priority among the different blockers and display visual indicators of such priority or arrange the display of the blockers in an order based on the priority, etc. This priority is based on thresholds the process experts provided based on their experience for what is considered good or bad for the process execution when they defined the blockers.

In some embodiments, each milestone may be associated with a document that is involved in the process such as an order, an invoice, a financial document, or the like. The blockers may refer to actions or other events/items within the process that block or otherwise prevent the milestone (e.g., the document) from being completed in some way such as incorrect content, not yet submitted, submitted and returned, canceled, etc. Furthermore, each of the milestones 410, 420, and 430, may identify the number of documents generated for the milestone and the percentage or ratio of such documents that compete the milestone. For example, in FIG. 4, the milestone 410 includes 13,400 documents (sales orders) being created, but only 4500 of the documents were eventually converted into invoices in the milestone 420. This correspond to a loss of about 66.6%. These insights can be provided to the user via the user interface 400.

FIG. 3B illustrates a process 330 of identifying milestones and blockers as a subset of the overall state space in accordance with an example embodiment. Referring to FIG. 3B, the entire process space of a business process is shown as state space 340. A traditional process mining approach would analyze the state space 340 in its entirety. In contrast, in the example embodiments, the host system may identify one or more milestones such as milestones 341, 342, 343, and 344, and blockers 350 for the respective milestones. In this example, the blocker 350 is a blocker for milestone 341. Each milestone may have its own respective blockers or it may not. For example, each milestone may include zero blockers, one blocker, more than one blocker, and/or the like. In this way, the process is only analyzed based on the key areas of the process associated with milestones (e.g., document creation, document submission, document clearing, etc.) instead of the entire state space which can take significantly more time.

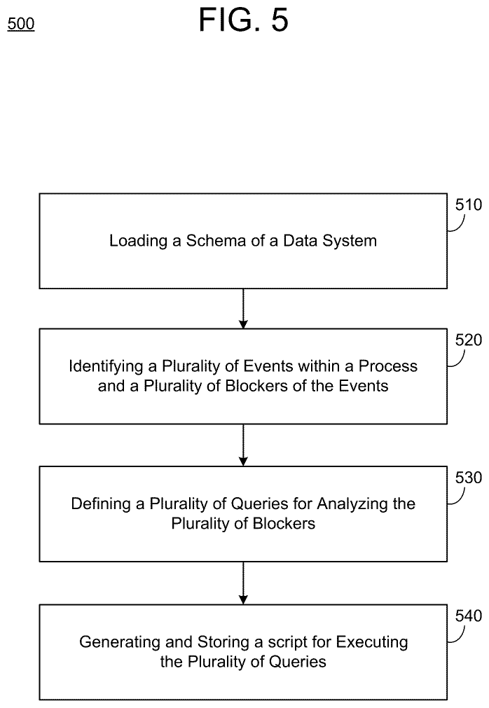

FIG. 5 illustrates a method 500 of generating an executable query for generating process insights in accordance with an example embodiment. For example, the method 500 may be performed by a software application hosted by a host platform such as a cloud platform, a web server, a distributed system, a database, or the like. Referring to FIG. 5, in 510, the method may include loading a schema of a data system into memory. The schema may include identifiers of data values, data types, table names, column names, locations of the system on network, and the like. The schema may be uploaded in the form of a file or via input on a user interface.

In 520, the method may include identifying a plurality of events that occur within a process supported by data from the data system and a plurality of blockers that prevent the plurality of events from completing. In 530, the method may include defining a plurality of queries for the plurality of blockers, respectively, wherein each query comprises instructions for extracting data for a respective blocker from the data system based on the schema and for executing the process based on the extracted data. In 540, the method may include generating a script for executing the plurality of queries and transmitting the script to a software application. The script may include instructions for executing a database query such as an SQL query. The script may also or instead include a series of calls to be made to an application programming interface (API) of the data system for retrieving the data for generating the process insights.

In some embodiments, the method may further include executing the script via the software application, wherein the executing comprises querying the data system for document data based on the plurality of defined queries via the software application, and executing the process based on the document data to generate process results based on the plurality of blockers. In some embodiments, the method may further include identifying an event and a plurality of blockers that prevent the event from being completed based on the generated process results, and displaying an identifier of the event and identifiers of the one or more blockers via a user interface. In some embodiments, the method may further include identifying a most urgent blocker from among the plurality of blockers based on a rate of occurrence of the most urgent blocker from the generated process results, and distinguishing a display of an identifier of the most urgent blocker from a display of identifiers of other blockers from among the plurality of blockers displayed on the user interface.

In some embodiments, the defining may include defining a plurality of structured query language (SQL) queries for accessing table data of the process from the data system, and the generating comprises generating a script for executing a single SQL query which includes a union of the plurality of SQL queries. In some embodiments, the identifying the plurality of events may include identifying a plurality of documents that are used by the process and locations of table data from the data system for filling in fields of the plurality of documents. In some embodiments, the identifying the plurality of blockers may include identifying a plurality of blocking events that prevent the plurality of documents from being completed during the process. In some embodiments, the defining may include defining a query for a blocker based on a document that is associated with the blocker and a location of table data from the data system for filling in fields of the document.

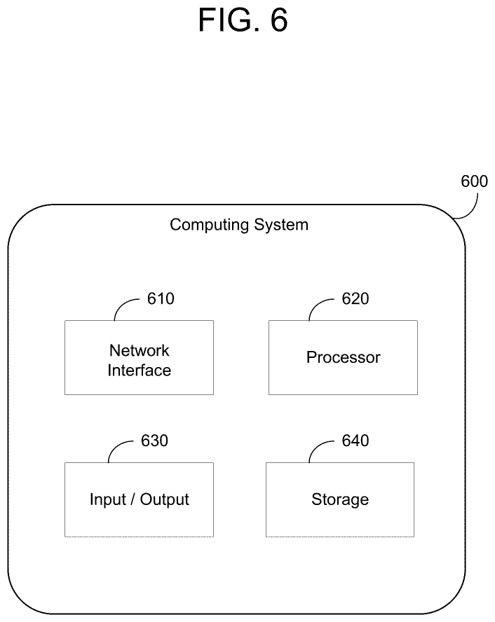

FIG. 6 illustrates a computing system 600 that may be used in any of the methods and processes described herein, in accordance with an example embodiment. For example, the computing system 600 may be a database node, a server, a cloud platform, or the like. In some embodiments, the computing system 600 may be distributed across multiple computing devices such as multiple database nodes. Referring to FIG. 6, the computing system 600 includes a network interface 610, a processor 620, an input/output 630, and a storage 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the methods described herein. According to various embodiments, the storage 640 may include a data store having a plurality of tables, records, partitions and sub-partitions. The storage 640 may be used to store database records, documents, entries, and the like.

According to various embodiments, the processor 620 may be configured to load a schema of a data system into memory. For example, the schema can be loaded into a software application that generates process insights such as an analytic software application. The processor 620 may also be configured to identify a plurality of events that occur within a process supported by data from the data system and a plurality of blockers that prevent the plurality of events from completing. The processor 620 may also be configured to define a query that comprises instructions for extracting data from the data system and for analyzing the plurality of blockers based on the extracted data. The processor 620 may also be configured to generate a script for executing the defined query based on the schema of the data system and transmit the script to a software application.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory medium.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a memory; and
a processor configured to
load a schema of a data system into memory,
identify a plurality of events that occur within a process supported by data from the data system and a plurality of blockers that prevent the plurality of events from completing,
define a query that comprises instructions for extracting data from the data system and for analyzing the plurality of blockers based on the extracted data, and
generate a script for executing the defined query based on the schema of the data system and transmit the script to a software application.

2. The computing system of claim 1, wherein the processor is further configured to execute the script via the software application, wherein the processor queries the data system for document data based on the defined query and processes the document data to generate results based on the plurality of blockers.

3. The computing system of claim 2, wherein the processor is configured to identify an event and one or more blockers that prevent the event from being completed based on the generated results, and display an identifier of the event and identifiers of the one or more blockers via a user interface.

4. The computing system of claim 3, wherein the processor is further configured to identify a most urgent blocker from among the plurality of blockers based on a rate of occurrence of the most urgent blocker from the document data, and distinguish a display of an identifier of the most urgent blocker from a display of identifiers of other blockers from among the plurality of blockers displayed on the user interface.

5. The computing system of claim 1, wherein the processor is configured to define a structured query language (SQL) query for accessing table data of the process from the data system, and generate a script for executing the SQL query which includes a union of a plurality of SQL queries.

6. The computing system of claim 1, wherein the processor is configured to identify a plurality of documents that are used by the process and locations of table data from the data system for filling in fields of the plurality of documents.

7. The computing system of claim 6, wherein the processor is configured to identify the plurality of blockers based on a plurality of blocking events that prevent the plurality of documents from being completed during the process.

8. The computing system of claim 7, wherein the processor is configured to define a query for a blocker based on a document that is associated with the blocker and a location of table data from the data system for filling in fields of the document.

9. A method comprising:
loading a schema of a data system into memory;
identifying a plurality of events that occur within a process supported by data from the data system and a plurality of blockers that prevent the plurality of events from completing;
defining a plurality of queries for the plurality of blockers, respectively, wherein each query comprises instructions for extracting data for a respective blocker from the data system based on the schema and for executing the process based on the extracted data; and
generating a script for executing the plurality of queries and transmitting the script to a software application.

10. The method of claim 9, wherein the method further comprises executing the script via the software application, wherein the executing comprises querying the data system for document data based on the plurality of defined queries via the software application, and executing the process based on the document data to generate process results based on the plurality of blockers.

11. The method of claim 10, wherein the method further comprises identifying an event and a plurality of blockers that prevent the event from being completed based on the generated process results, and displaying an identifier of the event and identifiers of the plurality of blockers via a user interface.

12. The method of claim 11, wherein the method further comprises identifying a most urgent blocker from among the plurality of blockers based on a rate of occurrence of the most urgent blocker from the generated process results, and distinguishing a display of an identifier of the most urgent blocker from a display of identifiers of other blockers from among the plurality of blockers displayed on the user interface.

13. The method of claim 9, wherein the defining comprises defining a plurality of structured query language (SQL) queries for accessing table data of the process from the data system, and the generating comprises generating a script for executing a single SQL query which includes a union of the plurality of SQL queries.

14. The method of claim 9, wherein the identifying the plurality of events comprises identifying a plurality of documents that are used by the process and locations of table data from the data system for filling in fields of the plurality of documents.

15. The method of claim 14, wherein the identifying the plurality of blockers comprises identifying a plurality of blocking events that prevent the plurality of documents from being completed during the process.

16. The method of claim 15, wherein the defining comprises defining a query for a blocker based on a document that is associated with the blocker and a location of table data from the data system for filling in fields of the document.

17. A computer-readable medium comprising instructions which when executed by a processor cause a computer to perform a method comprising:
loading a schema of a data system into memory;
identifying a plurality of events that occur within a process supported by data from the data system and a plurality of blockers that prevent the plurality of events from completing;
defining a query that comprises instructions for extracting data of the plurality of blockers from the data system and for analyzing the process based on the extracted data and the plurality of blockers; and
generating a script for executing the defined query based on the schema of the data system and transmit the script to a software application.

18. The computer-readable medium of claim 17, wherein the method further comprises executing the script via the software application, wherein the executing comprises querying the data system for document data based on the defined query and processing the document data to generate results.

19. The computer-readable medium of claim 18, wherein the executing further comprises identifying an event and a blocker that prevents the event from being completed based on the generated results, and displaying an identifier of the event and an identifier of the blocker via a user interface.

20. The computer-readable medium of claim 18, wherein the identifying the plurality of blockers comprises identifying a plurality of blocking events that prevent a plurality of documents from being completed during the process based on the generated results.
